(19) United States
(12) Patent Application Publication
(10) Pub. No.: US 2006/0120676 A1
(43) Pub. Date: Jun. 8, 2006

(54) Slotted-core ribbon optical cable

(75) Inventors: Hee-Goo Kang, Andong-si (KR); Kyung-Tae Park, Gumi-si (KR); Jin-Han Kim, Gumi-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/221,121

(22) Filed: Sep. 7, 2005

(30) Foreign Application Priority Data
Dec. 8, 2004 (KR) 2004-103060

(51) Int. Cl. G02B 6/44

(52) U.S. Cl. 385/105; 385/114

(57) ABSTRACT

A slotted-core ribbon optical cable includes ribbon optical fiber bundles including a plurality of ribbon optical fibers being stacked on top of each other, a slot section having at least two recesses for accommodating the ribbon optical fiber bundles therein, and an outer jacket surrounding the slot section, wherein a coefficient of static friction between the ribbon optical fiber bundle and the recess of the slot section is set to below 0.5.

### CLAIM OF PRIORITY

This application claims the benefit of an earlier application entitled “Slotted-Core Ribbon Optical Cable,” filed with the Korean Intellectual Property Office on Dec. 8, 2004 and assigned Serial No. 2004-103060, the entire contents of which are incorporated herein by reference.

### BACKGROUND OF THE INVENTION

1. Field of the Invention

The present invention relates to an optical cable. More particularly, the present invention relates to a slotted-core ribbon optical cable having a slot section for accommodating a plurality of ribbon optical cable bundles therein.

2. Description of the Related Art

An optical cable typically includes a plurality of optical fibers and a protective member for protecting the optical fibers. The optical cable is further provided with a tension member for reinforcing tensile force of the optical fibers and a waterproof member for preventing water from penetrating into the optical fibers.

The above optical cables may be classified into different types according to the number of the optical fibers and its installation places thereof, i.e., single-fiber optical cables, loose tube optical cables, and ribbon optical cables.

The single-fiber optical cable is used as a wiring for an apparatus or as a wiring means between apparatuses. The single-fiber optical cable includes an optical fiber and a cladding layer formed on the optical fiber.

The loose tube optical cable is formed by binding a plurality of loose tubes including a plurality of optical fibers therein. The loose tube optical cable may further include a tension member for reinforcing tensile force of the optical fibers.

The ribbon optical cable includes a ribbon optical fiber bundle having at least one ribbon optical fiber. In general, the ribbon optical cable includes a plurality of optical fibers aligned in series and a coating layer coated on the optical fibers in order to bind the optical fibers. An UV (ultraviolet) curing agent is mainly used for the coating layer. The ribbon optical fiber bundle is formed by stacking a plurality of ribbon optical fibers. The ribbon optical cable further includes a slot section having a plurality of U-shaped recesses for accommodating the ribbon optical fiber bundles therein. The ribbon optical cable can be easily fabricated and managed.

However, the ribbon optical cable presents a problem because the shrinkage rate of the ribbon optical fiber bundles in the slot section is different from that of the slot section. That is, if the ribbon optical cable is subject to an external impact, such as bending, or sudden temperature variation, a lay ratio of the ribbon optical cable may irregularly vary due to the difference in the shrinkage rate between the slot section and the ribbon optical fiber bundle. As a result, the ribbon optical fiber may be damaged by the slot section.

### SUMMARY OF THE INVENTION

Accordingly, the present invention has been made to solve the above-mentioned problems occurring in the prior art and provides additional advantages, by providing a slotted-core ribbon optical fiber capable of preventing ribbon optical fibers from being damaged due to the difference in the shrinkage rate between a slot section and a ribbon optical fiber bundle.

In one embodiment, there is provided a slotted-core ribbon optical cable comprising: ribbon optical fiber bundles including a plurality of ribbon optical fibers being stacked; a slot section having at least two recesses for accommodating the ribbon optical fiber bundles therein; and an outer jacket surrounding the slot section, wherein a coefficient of the static friction between the ribbon optical fiber bundle and the recess of the slot section is set to below 0.5.

### BRIEF DESCRIPTION OF THE DRAWINGS

The above features and advantages of the present invention will be more apparent from the following detailed description taken in conjunction with the accompanying drawings, in which:

FIG. 1 is a sectional view illustrating a structure of a slotted-core ribbon optical cable according to an embodiment of the present invention; and

FIG. 2 is a graph illustrating the loss variation as a function of a coefficient of the static friction between a ribbon optical fiber and a slot section.

### DETAILED DESCRIPTION

Hereinafter, embodiments of the present invention will be described with reference to the accompanying drawings. For the purposes of clarity and simplicity, a detailed description of known functions and configurations incorporated herein will be omitted as it may make the subject matter of the present invention unclear.

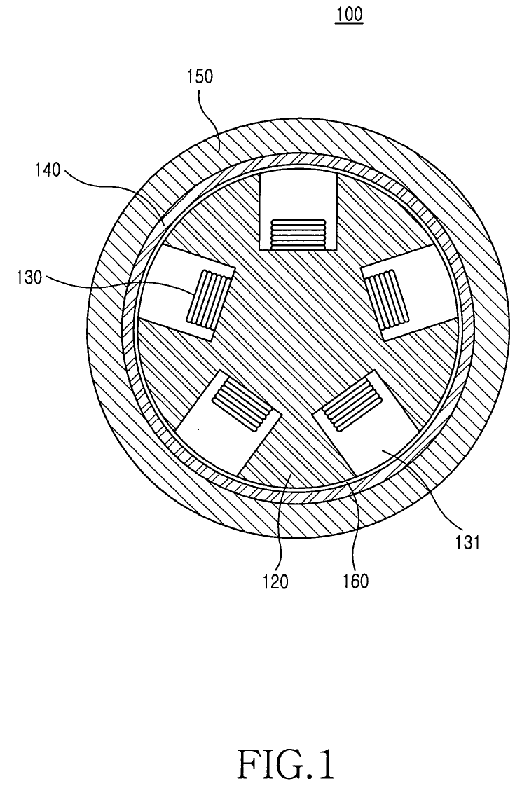

FIG. 1 is a sectional view illustrating a structure of a slotted-core ribbon optical cable 100 according to an embodiment of the present invention. As shown, the slotted-core ribbon optical cable 100 of the present invention includes a slot section 120 including a plurality of recesses 131, ribbon optical fiber bundles 130 disposed in the recesses 131, an absorption tape 160 surrounding the slot section 120, a protective layer 140, and an outer jacket 150.

The number of optical fiber circuits accommodated in the recesses 131 may increase proportionally to the number of recesses 131 of the slot section 120. Thus, the slotted-core ribbon optical cable 100 is adaptable for a telephone office or an office building requiring a great amount of optical fiber circuits. The recesses 131 are filled with waterproof yarns or fillers in addition to the ribbon optical fiber bundles 130. Each recess 131 can be formed in an S/Z pattern or can be helically formed lengthwise along the slot section 120.

The ribbon optical fiber bundle 130 is formed by stacking a plurality of ribbon optical fibers, in which each ribbon optical fiber includes a coating layer coated on the optical fibers for binding the optical fibers aligned in series. The coating layer may include a polymeric material, an UV curing agent or PVDF.

Note that it is necessary to take friction between the recess 131 of the slot section 120 and the ribbon optical fiber bundle 130 into consideration in order to manage the lay ratio of the slotted-core ribbon optical cable 100. Otherwise, a part of the ribbon optical fiber bundle 130 making contact with a bottom portion of the recess 131 may be damaged due to friction between the ribbon optical fiber bundle 130 and the bottom portion of the recess 131.

The protective layer 140 includes glass yarn or aramid yarn in the form of a strand, which is made by processing glass, nylon or aramid having higher mechanical strength with superior workability. A nylon coating layer can be used for the protective layer 140.

The absorption tape 160 includes a waterproof tape capable of preventing water from penetrating into the ribbon optical fiber bundles 130.

The outer jacket 150 prevents the slotted-core ribbon optical cable 100 from being worn out due to external impact and protects elements of the slotted-core ribbon optical cable 100 from external environment. The outer jacket 150 is made from polymer materials, such as polyethylene or polyvinylchloride.

In addition, slotted-core ribbon optical cable 100 can be provided at a center portion thereof with at least one central tension member.

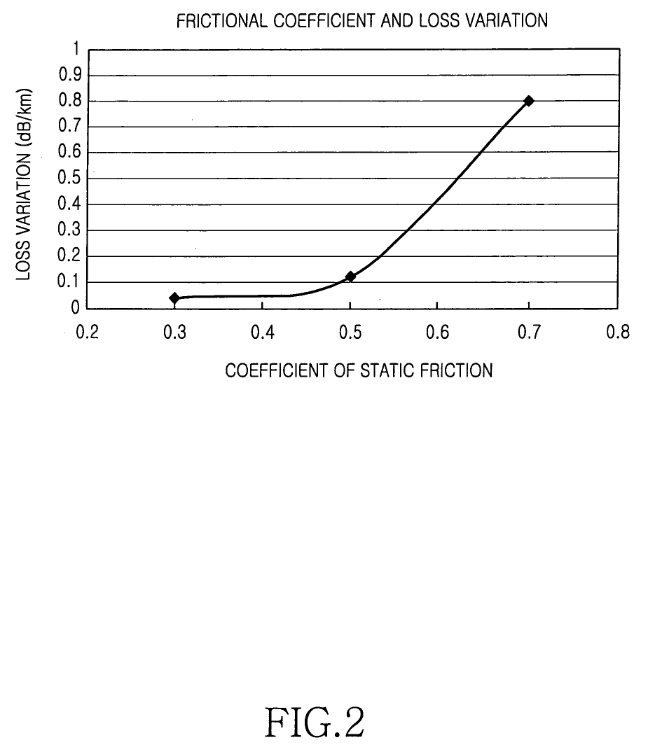

FIG. 2 is a graph illustrating the loss variation as a function of a coefficient of static friction between the ribbon optical fiber bundle 130 and the corresponding recess 131 of the slot section 120 when the slotted-core ribbon optical cable 100 is exposed to temperature variation between −40 to −70° C.

Referring to FIG. 2, if the coefficient of static friction between the recesses 131 and the ribbon optical fiber bundles 130 is lower than 0.5, the loss change is less than 0.1 dBm/km. However, as the coefficient of static friction between the recesses 131 and the ribbon optical fiber bundles 130 exceeds 0.5, the loss change is suddenly increased. Accordingly, the loss of the optical signal generated under low-temperature environment can be restricted to a level below 0.1 dBm/km if the coefficient of static friction between the recesses 131 and the ribbon optical fiber bundles 130 is lower than 0.5.

As mentioned above, according to the slotted-core ribbon optical cable of the present invention, the coefficient of static friction between the ribbon optical fiber bundle and the recess of the slot section is set to below 0.5, so that it is easy to manage the slotted-core ribbon optical cable, and the optical signal can be stably transmitted. Since the coefficient of static friction between the ribbon optical fiber bundle and the recess of the slot section is maintained at a lower level, it is easy to manage the lay ratio of the ribbon optical fiber bundles accommodated in the recesses of the slot section.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A slotted-core ribbon optical cable comprising:
ribbon optical fiber bundles provided by stacking a plurality of ribbon optical fibers;
a slot section having at least two recesses for accommodating the ribbon optical fiber bundles therein; and
an outer jacket surrounding the slot section, wherein a coefficient of static friction between the ribbon optical fiber bundle and the recess of the slot section is set to below 0.5.

2. The slotted-core ribbon optical cable as claimed in claim 1, further comprising a waterproof tape surrounding the slot section and a protective layer interposed between the waterproof tape and the outer jacket.

3. The slotted-core ribbon optical cable as claimed in claim 2, wherein the protective layer includes glass yarn.

4. The slotted-core ribbon optical cable as claimed in claim 2, wherein the protective layer includes aramid yarn.

5. The slotted-core ribbon optical cable as claimed in claim 2, wherein the protective layer includes a nylon coating layer.

6. The slotted-core ribbon optical cable as claimed in claim 1, wherein each recess is formed in an S/Z pattern.

7. The slotted-core ribbon optical cable as claimed in claim 1, wherein each recess is helically formed lengthwise along the slot section.

8. A method for providing a slotted-core ribbon optical cable comprising:
providing a slot section having a plurality of recesses;
providing ribbon optical fiber bundles in the plurality of recesses; and
providing an outer jacket surrounding the slot section, wherein a coefficient of static friction between the ribbon optical fiber bundle and the plurality of recess is set to below 0.5.

9. The method of claim 8, wherein the ribbon optical fiber bundles is provided by stacking a plurality of ribbon optical fibers.

10. The method of claim 8, further comprising providing a waterproof tape surrounding the slot section and a protective layer interposed between the waterproof tape and the outer jacket.

11. The method of claim 8, wherein each recess is formed in an S/Z pattern.

12. The method of claim 8, wherein each recess is helically formed lengthwise along the slot section.

13. The method of claim 10, wherein the protective layer includes glass yarn.

14. The method of claim 10, wherein the protective layer includes aramid yarn.

15. The method of claim 10, wherein the protective layer includes a nylon coating layer.
